(19) United States
(12) Patent Application Publication
(10) Pub. No.: US 2017/0323189 A1
(43) Pub. Date: Nov. 9, 2017

(54) ACTIVE RFID-BASED REAL TIME LOCATION SYSTEMS

(71) Applicant: International Business Machines Corporation, Armonk, NY (US)

(72) Inventors: Josephine B. Chang, Ellicott City, MD (US); Patrick L. Coval, East Rochester, NY (US); Hendrik F. Hamann, Yorktown Heights, NY (US); Alvin Wade Kelley, Grapevine, TX (US); Pinzhi Zhang, White Plains, NY (US)

(21) Appl. No.: 15/146,915

(22) Filed: May 5, 2016

(51) Int. Cl. G06K 19/07; G06Q 10/06; G06N 99/00; H04W 4/02; H04B 17/318

(52) U.S. Cl. CPC G06K 19/0723; H04W 4/028; H04B 17/318; G06N 99/005; G06Q 10/063114

(57) ABSTRACT

A computer-implemented method includes identifying one or more tag readers. The one or more of tag readers are positioned peripherally to a region. The computer-implemented method further includes receiving a signal, by at least one of the one or more tag readers, from a tag. The computer-implemented method further includes determining a received signal strength indication for at least one of the one or more tag readers and mapping at least one received signal strength indication onto at a one dimensional representation of the region to yield a mapped data. The computer-implemented method further includes performing pattern recognition on the mapped data to yield a pattern data and applying machine learning to the pattern data to locate the tag within the region. A corresponding computer system and computer program product are also disclosed.

### BACKGROUND

The present invention relates generally to the field of Real Time Location Systems (RTLS), and more particularly to RTLS that are based on active Radio-Frequency IDentification (RFID).

RTLS enable organizations to track the movement of people and assets in a space. Classic examples include the movement of goods, employees, and equipment through a facility. RTLS may be based on any of a variety of location sensing technologies, one of which is active RFID. In active RFID, powered tags transmit an identifying beacon at all times, which are received by various reader devices. This is as opposed to passive RFID, where an otherwise unpowered device receives energy from a probing signal in sufficient amount to transmit its own identifying beacon. RTLS based on active RFID may rely upon measurements of Received Signal Strength Indication (RSSI) detected at multiple reader devices to locate a tag in a defined space.

### SUMMARY

A computer-implemented method includes identifying one or more tag readers. The one or more of tag readers are positioned peripherally to a region. The computer-implemented method further includes receiving a signal, by at least one of the one or more tag readers, from a tag. The computer-implemented method further includes determining a received signal strength indication for at least one of the one or more tag readers and mapping each received signal strength indication onto a one dimensional representation of the region to yield a mapped data. The computer-implemented method further includes performing pattern recognition on the mapped data to yield a pattern data and applying machine learning to the pattern data to locate the tag within the region. A corresponding computer system and computer program product are also disclosed.

### BRIEF DESCRIPTION OF THE DRAWINGS

FIG. 1 is a block diagram depicting various components of an operational environment for a one dimensional RTLS program, in accordance with at least one embodiment of the invention.

FIG. 2 is a flowchart diagram depicting various operational steps for a one dimensional RTLS program, in accordance with at least one embodiment of the invention.

FIG. 3A is a plot of an exemplary curve relating RSSI data from an active RFID reader for a tag located in or around an aircraft, for a system, in accordance with at least one embodiment of the invention.

FIG. 3B is a plot of exemplary RSSI data with respect to time for one tag signal received by an active RFID reader, for a system, in accordance with at least one embodiment of the invention.

FIG. 4 is a plot of exemplary RSSI data with respect to time for two active RFID readers for a tag located in or around an aircraft, for a system, in accordance with at least one embodiment of the invention.

FIG. 5A is a bar graph of expected RSSI data for an active RSSI reader located at a gate of an airport apron received from a tag at or around various nearby gates, for a system, in accordance with at least one embodiment of the invention.

FIG. 5B is a plot of exemplary RSSI data with respect to time for an active RSSI reader located at a gate of an airport apron received from a tag at or around various nearby gates, for a system, in accordance with at least one embodiment of the invention.

FIG. 6 is a block diagram depicting various logical elements for a computer system capable of executing program instructions, in accordance with at least one embodiment of the present invention.

### DETAILED DESCRIPTION

RTLS systems have become widely use to track people and assets in a variety of contexts. One technology underlying RTLS systems is active RFID. Existing RTLS systems, whether based on active RFID or not, generally rely on hardware (i.e., physical reader devices) located a multiple reference points around and/or within the field or region of interest. Multiple reader devices at dimensionally disparate locations are required for triangulation of signals tag signals to locate a tag in a fully modeled three dimensional space. The Inventors have observed and/or recognized that the hardware positioning requirements for existing RTLS systems are less useful in certain restricted environments, such as in an airport apron (“apron” as used herein means the area of tarmac adjacent to an airport terminal in which aircraft are parked for loading and servicing). Other potential restricted environments include marinas, manufacturing floors, warehouses, mines, spaceports, hospitals, military facilities, and correctional facilities.

In the particular context of an airport apron, the environment is heavily regulated (i.e., in terms of what persons and equipment may be present) due to safety concerns: hardware may only be installed around the periphery of the three-dimensional airport apron. In general regions where it may be beneficial to apply the invention include regions subject to one more equipment restrictions. Acceptable locations for the installation of hardware, such as active RFID readers, may generally be found around the periphery of the airport apron or other region of interest. For example, hardware may be installed on or under the jet bridge, jet bridge ramp, or terminal building, leaving the tarmac clear for aircraft and service vehicles. However, the inventors have further observed and/or recognized that peripherally located devices may be insufficient for accurate positioning within an unconstrained three dimensional space, or even within a two dimensional map.

The inventors have further observed and/or recognized that movement is restricted through and around an aircraft and its immediate surroundings due to the front-back configuration of the aircraft. This is particularly true of large commercial airliners which have multiple sections in which the same service task must be done repetitively: cleaning seats, emptying waste, applying de-icing agents, loading and unloading luggage, conducting mechanical inspections, and many other service tasks are all tasks that progress up and down the length of the aircraft. Thus, in the context of the present invention, such tasks may be classed as interactively linear.

In contrast to a literal linear space, which is a mathematical line or line segment, an interactively linear space may be understood as a three dimensional space that is physically restricted in two dimensions, leaving a third dimension pertinent to some task or inquiry. In the case of an aircraft cabin, a worker can move up and down the length of the aircraft using the aisles fairly freely, but can only access space a short distance to the left or right (into the seats) or up and down (between floor level, seat level, and overhead bin level). Thus, an aircraft cabin is an interactively linear space. Similarly, for the tarmac immediately under or around the aircraft, a worker can access underneath the plane by moving along the ground up and down the dimension of the length of the aircraft, however the worker cannot easily access up into the aircraft or down into the ground, and travel too far in either horizontal direction leads the worker out of the relevant region (the gate area) and into a different one (an adjacent gate area). Thus, the tarmac immediately under or around the aircraft cabin is an interactively linear space.

Interactively linear spaces exist in other contexts. For example, an aisle in a warehouse may require essentially linear stocking and unstocking activity, a row of fruit or vegetable crop may require essentially linear picking, sewing, or other servicing, and a hospital or hotel hallway may require essentially linear cleaning. All of these and other regions can be classed as interactively linear for purposes of tracking some relevant movement therethrough.

Thus, the inventors have further observed and/or recognized that RTLS can leverage the constraint of interactively linear spaces to perform localization with fewer and/or more peripheral reader devices than would otherwise be needed to localize a tag in an unconstrained three dimensional or two dimensional representation of a region. Accordingly, by mapping reader RSSI data onto a one dimensional representation of an interactively linear space, RTLS can achieve localization under comparatively adverse conditions, in accordance with the present invention.

While the foregoing paragraphs may recite possible advantages of the invention and/or solutions to problems, it will be understood that each described advantage need not necessarily be present in any particular embodiment of the invention and that any particular embodiment of the invention need necessarily solve any particular problem.

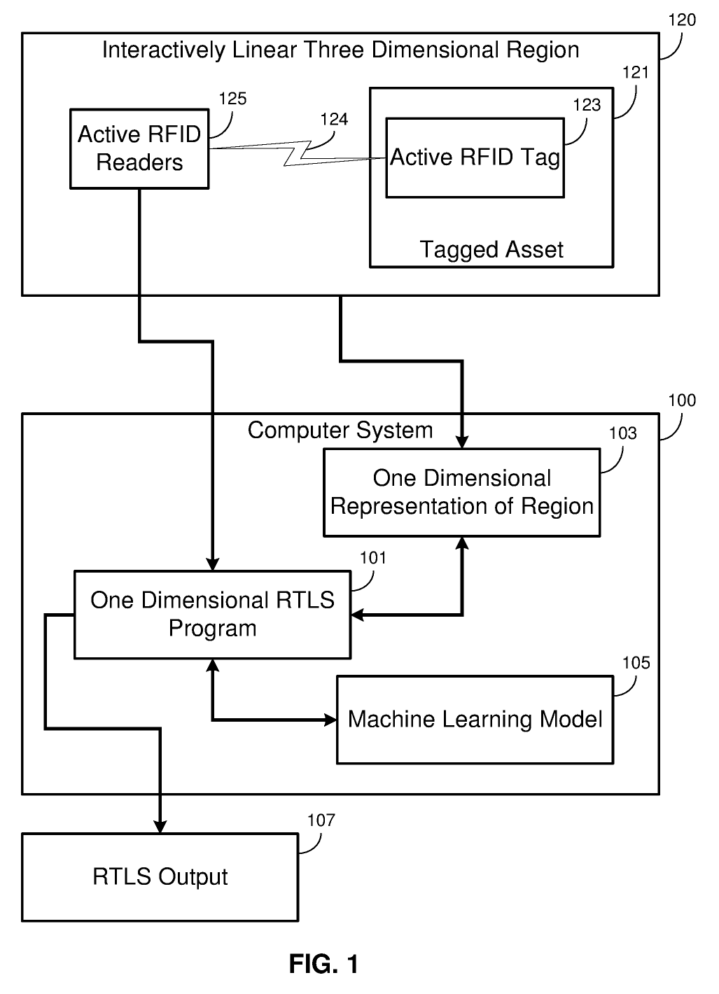

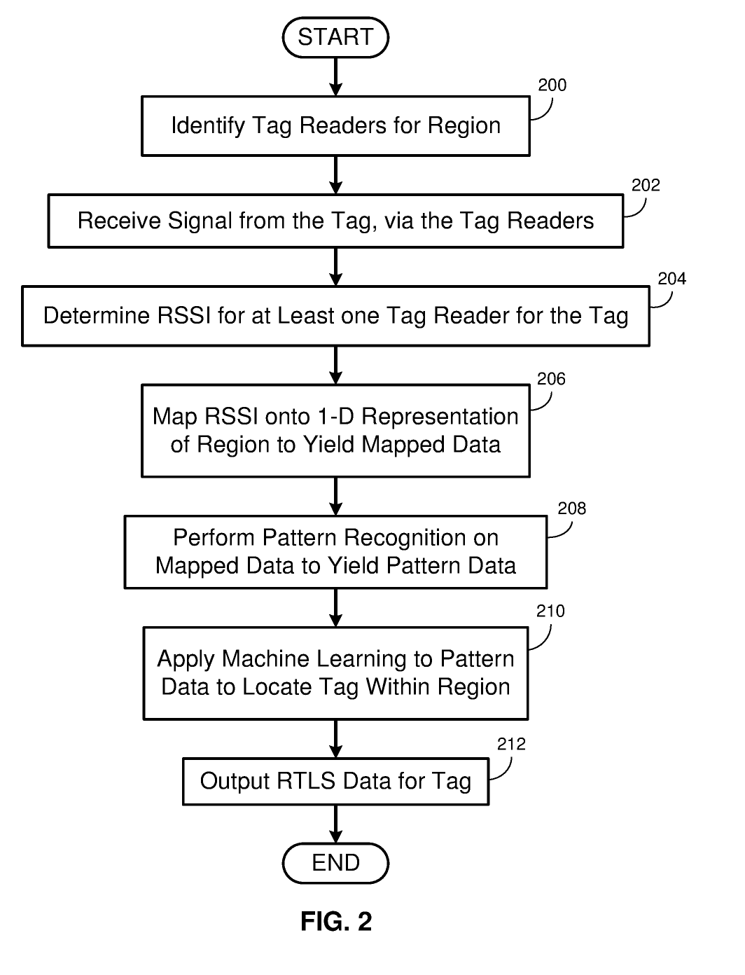

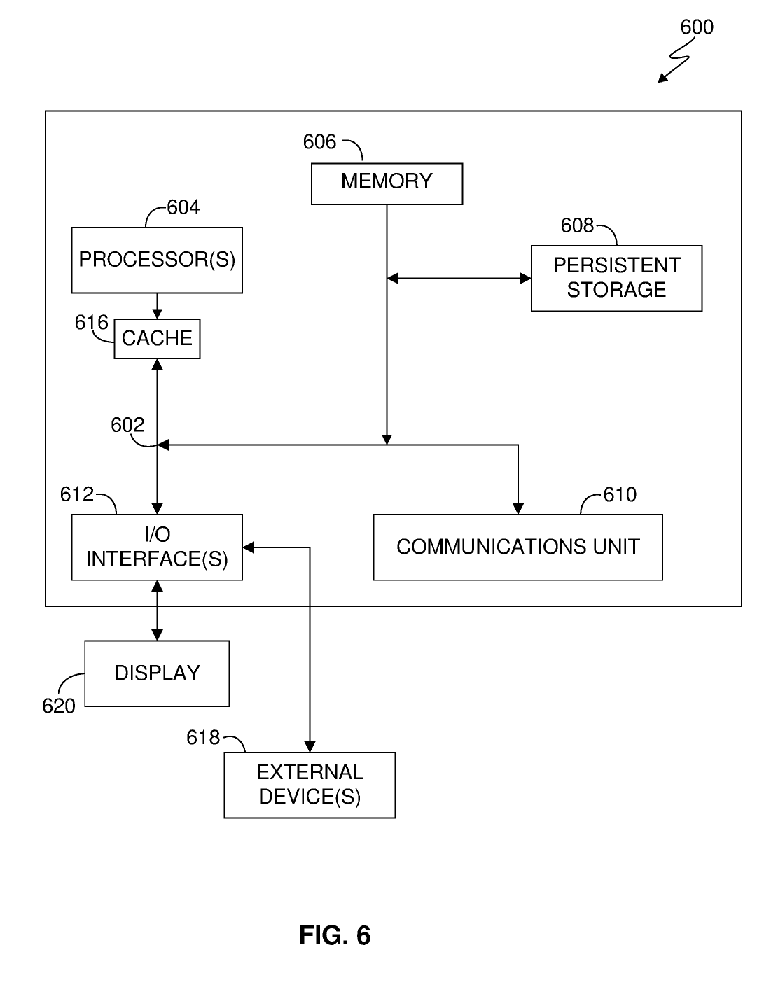

Referring now to FIG. 1, FIG. 1 is a block diagram depicting various components of and relating to a computer system 100, in accordance with at least one embodiment of the invention. The computer system 100 may be of the general kind depicted in FIG. 6. Additionally, the computer system may include any physical, virtual, localized, or distributed computer or computers, including cloud environments, client/server environments, desktop or laptop workstations, and mobile devices. Running and/or operating on the computer system 100 is a one dimensional RTLS program 101, which, in the depicted embodiment, performs the operational steps of the invention, for example, those steps depicted in FIG. 2.

In the depicted embodiment, the one dimensional RTLS program 101 accesses a one dimensional representation 103 of an interactively linear three dimensional region 120. Installed and/or positioned peripherally to the interactively linear three dimensional region are one or more active RFID readers 125. In one contemplated embodiment, the active RFID readers 125 are two in number and installed peripherally to an airport apron surrounding a gate equipped with a jet bridge. Specifically, in such an embodiment, one active RFID reader is installed underneath the jet bridge and another on top of the jet bridge, both proximate, in the dimension of interest, to the front end of the aircraft. In alternative embodiments, other technologies than active RFID may be employed. For example, Wi-Fi, radio beacons, infrared, ultrasound, and Bluetooth may enable the RSSI measurements taken for purposes of the invention. More generally, any technology now known or later discovered that supports range finding between a moving tag and a fixed read over the pertinent distance scales (e.g., meters to tens of meters for an aircraft, jet bridge, and gate area). In the depicted embodiment, the active RFID readers 125 are contemplated to measure RSSI for a signal 124 from an active RFID tag 123. The active RFID readers 125 may be configured, therefore, to both distinguish the identity of the active RFID tag 123 from other tags in the environment, based on the content of the signal 124 as well as the RSSI, which is a measurement of the strength of the signal 124.

With respect to the contemplated embodiment wherein the interactively linear three dimensional region 120 is an airport apron, the region may include at least one space associated with an aircraft selected from the group consisting of: (a) a cabin of said aircraft; (b) a tarmac area beneath said aircraft; (d) a jet bridge associated with said aircraft; (e) a cargo hold of said aircraft; (f) a first airport gate area associated with said aircraft; and (g) a second airport gate area proximate to said first airport gate area.

Referring still to the embodiment depicted in FIG. 1, the active RFID tag 123 is affixed to a tagged asset 121. The tagged asset 121 may include a service vehicle, such as a cleaning cart, baggage truck, or vacuum service truck, and the active RFID tag 123 may be affixed to the physical structure of the vehicle. The tagged asset 121 may also include a piece of equipment carried or used by a person that is not a vehicle. Examples include cleaning equipment, diagnostic equipment, and communication equipment, including mobile phones, tablets, handheld radios, and other portable devices that may be carried. Finally, the tagged asset 121 may include a service worker or other personnel who wears the active RFID tag 123 by affixing the active RFID tag 123 to their clothing. In the case of a vehicle having an electrical system or a portable electronic device, the active RFID tag 123 may be integrated with and powered from the vehicle or device. For standalone active RFID tags 123, a dedicated battery may be provided as a power source, and the battery may be integrated with the active RFID tag. Such standalone tags may be affixed to the tagged asset 121 by any fastening means.

Referring still to the embodiment depicted in FIG. 1, the one dimensional RTLS program 101 may receive RSSI data from the active RFID readers 125 and apply the RSSI data to the one dimensional representation 103. The one dimensional representation 103 may be modeled, within the context of the computer system 100, by a scale that projects measured RSSI data onto a single spatial dimension. Specifically, the single spatial dimension chosen is the dimension of interest for the interactively linear three dimensional region 120. In one contemplated embodiment, where the interactively linear three dimensional region 120 corresponds to an aircraft parked at a gate section of airport apron, the dimension of interest corresponds to the nose-tail length of the aircraft. Using the one dimensional representation 103, the one dimensional RTLS program interacts with a machine learning model, which provides the relationship between patterns in the one dimensional representation 103 with respect to time and real-world positioning within the interactively linear three dimensional region. The one dimensional RTLS program 101 also provides RTLS output 107. The RTLS output 107 includes real-time positioning data for the tagged asset 121, which can be provided electronically to any system that accepts and uses RTLS data for the tagged asset 121, such as a software program that estimates the completion time for service tasks, as further described below.

Referring now to FIG. 2, FIG. 2 is a flowchart diagram for a one dimensional RTLS program 101, in accordance with at least one embodiment of the present invention. At step 200, the one dimensional RTLS programs 101 identifies one or more tag readers, such as the active RFID readers 125. The one or more of tag readers are positioned peripherally to a region, such as the interactively linear three dimensional region. More particularly, step 200 can include defining a data structure and filling the data structure with instantiated objects that include methods and functions for receiving RSSI data from the various readers and distinguishing among tags, based on the content of each tag's identity signal. Peripheral locating the tag readers includes, for any region, physical placement outside of a primary work area that must be kept clear of installed equipment. In the context of the airport apron surrounding a gate, the periphery can include the terminal building and jet bridge, structures that are present in the absence of the invention, and to which equipment can be safely affixed. In other types of regions, the available peripheral locations may vary. Generally, any non-obstructive location where equipment can be safely installed and where a sufficiently strong signal for RSSI measurements or alternative range finding technology can be received.

Referring still to the embodiment depicted in FIG. 2, at step 202, the one dimensional RTLS program 101 receives a signal, by at least one of the one or more tag readers, from a tag. The number of installed tag readers may vary for different embodiments. Similarly, for various embodiments and tag locations, only a subset of the readers may receive any signal. Thus, the one dimensional RTLS program may proceed on any number of received signals. At step 204, the one dimensional RTLS program determines a received signal strength indication for at least one of the one or more tag readers. In general, RSSI is represented as a unitless number suitable for comparison between devices of the same type and/or similar deployment. The measured RSSI may be outputted by the readers themselves or the one dimensional RTLS program 101 may compute RSSI data from more basic underlying parameters collected at each reader. Additionally, in one contemplated embodiment, the received signal strength indication includes a time series of computer RSSI values. This permits modeling the movement of each tag over time.

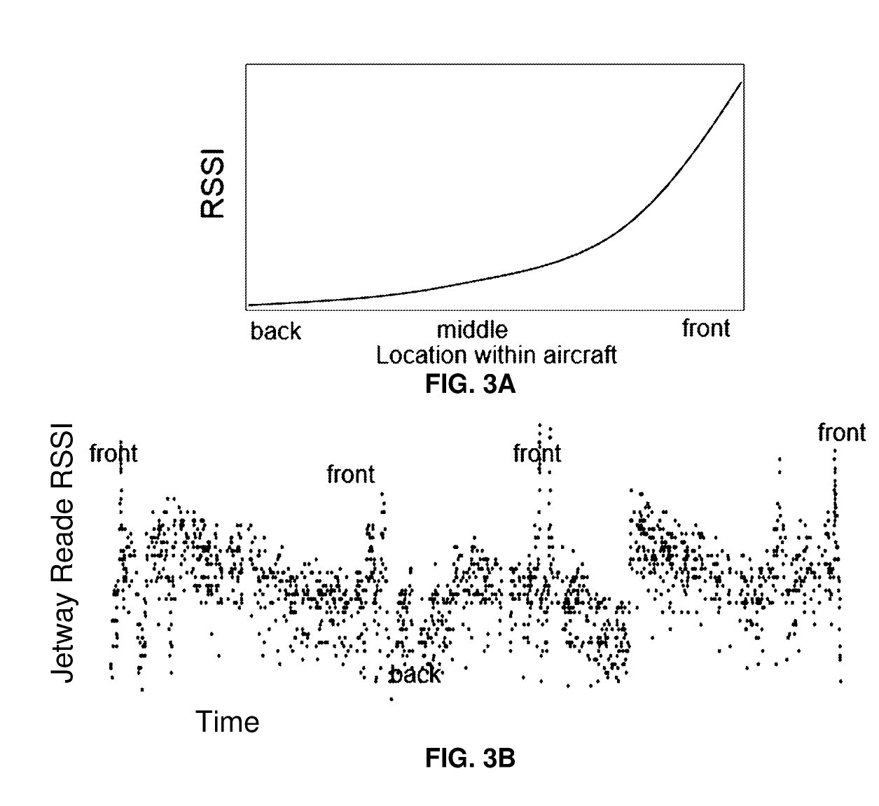

At step 206, the one dimensional RTLS program 101 maps at least one received signal strength indication onto a one dimensional representation of the region to yield a mapped data. The mapped data may include a plot the received signal strength indication against a time series. More specifically, the RSSI data taken over time may be stored in a data structure, for example as key-value pairs or as a list of tuples in a manner that is readily represented as a plot of RSSI versus time. FIG. 3B depicts exactly such a plot wherein each data point represents an RSSI value at a particular time for a single active RFID tag detected at a single RFID reader. FIG. 3A is a graph that shows how the mapped data plot can be interpreted with reference to an aircraft region. In the embodiment of FIG. 3A, an active RFID reader is positioned near the front of an aircraft parked at a gate. The RSSI number in itself is a scalar: it contains no direction information, only something proportional to the active RFID tag's range from the active RFID reader, regardless of direction. By projecting the directionless RSSI data onto the constrained single dimension of the aircraft and its surroundings, it becomes possible to move from a time series of RSSI to a mapping representing the physical environment of the region. The graph of FIG. 3A shows how RSSI increases as the active RFID tag becomes more proximate as it approaches the front of the aircraft and decreases as the active RFID tag approaches the rear of the aircraft. Alternative interpretations of the RSSI, such as the active RFID tag moving up and down at a nearby gate, can be discounted in the simplistic model of FIG. 3A. Accordingly, it becomes possible to identify visits to the front and back of the aircraft, as marked on FIG. 3B.

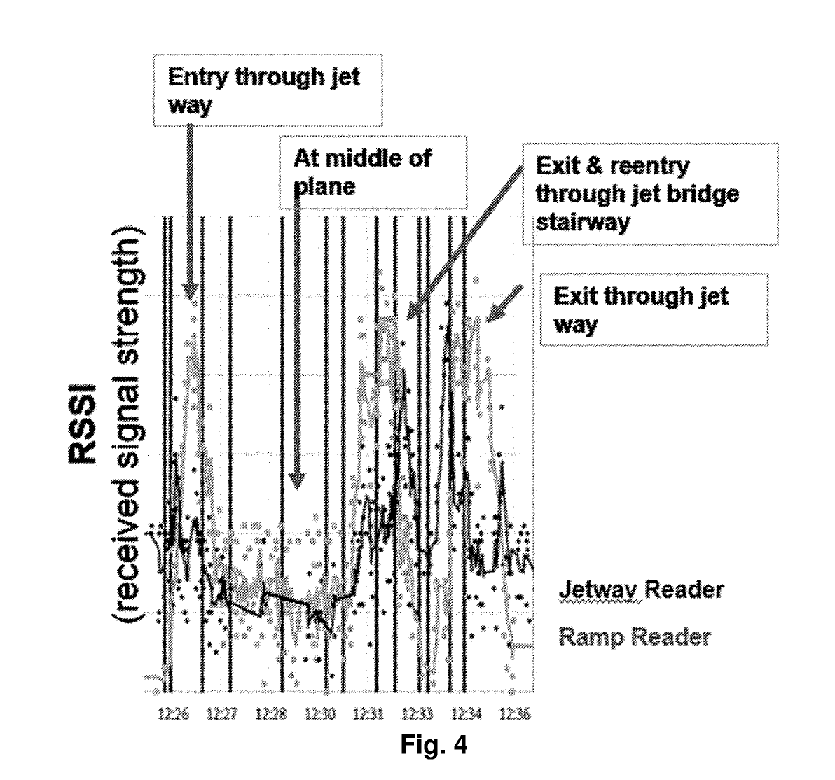

Referring now to FIG. 4, FIG. 4 depicts mapped RSSI data for two active RFID readers, one designated a “Jetway Reader” in black and the other designated a “Ramp Reader” in light gray. The two readers provide two different time series which, in combination, provide a richer pattern for analysis than a single time series. As shown, combinations of readings are combined to designate different events in the motion of a tag, for example one worn by an aircraft cleaning crew member.

Referring still to the embodiment depicted in FIG. 2, at step 208, the one dimensional RTLS program 101 performs pattern recognition on the mapped data to yield a pattern data. More specifically, patterns, such as the two-signal pattern of FIG. 4 can be categorized into the signatures of specific events. Using machine pattern recognition techniques, the one dimensional RTLS program 101 identify which events correspond to which signatures. At step 210, the one dimensional RTLS program 101 applies machine learning to the pattern data to locate the tag within the region. The machine learning may be achieved with a trained model such as the machine learning model 105. The machine learning model may be pre-trained on exemplary data from the region and active RFID system. Exemplary data may include multi-reader RSSI time series patterns similar to that depicted in FIG. 4. At step 212, the one dimensional RTLS program 101 may output RTLS data, designating real time location information for the tag, which may in turn be used by various systems that may derive further information from tracking the tag.

In various alternative embodiments, applying machine learning can include categorical regression analysis, wherein patterns of mapped data are explicitly categorized before being compared to the machine learning model 105. Additionally, the machine learning model 105 may be continuously refined from its original training as it experiences live data. Continuous refinement allows for changes in business rules to be captured as they occur. Where full-blown machine learning is unavailable or impractical, fixed rules and heuristics can attempt to model activity patterns in the mapped data. For example, a pattern of movement from front to back inside the aircraft and back again two or three times may be coded as a triggering rule to be identified as a cleaning crew member cleaning the aircraft. Similarly, an even simpler heuristic, value thresholding, can determine whether a tag is present or not in a particular linear space. These techniques may be applied alone or in combination with each other or machine learning to achieve RTLS in the context of the invention.

In various embodiments, such as where active RFID is utilized, the signal 124 includes identification information. In such embodiments, the one dimensional RTLS program 101 determines an identifier for the tag, based on the signal, such as the signal 124 from the active RFID tag 123. The one dimensional RTLS further determines, based on the identifier, one or more business rules relating to the tag. More concretely, the identifier can be used to query a database that relates tags to assets. The particular asset determines the business rules. For example, an asset that is a vacuum service truck is associated with vacuuming waste from aircraft storage tanks, and it is valid to infer that the asset, when its tag is proximate to the reader, is on the tarmac beneath the aircraft and/or jet bridge, and not inside the aircraft, jet bridge, or terminal building. Similarly, for a tag worn by a cleaning crewmember, the business rules provide the expected behavior for travelling through the aircraft and entering and exiting the same. The exemplary events shown in FIG. 4 illustrate these kinds of movements. Accordingly, step 210, wherein the one dimensional RTLS program 101 applies machine learning to the pattern date to locate the tag within the region, may be understood as being based on the one or more business rules. That is, the one dimensional RTLS program 101 may incorporate information about the expected behavior of the asset into the localization decision, whether by pre-categorizing the mapped data before applying the machine learning model 105, or by incorporating the business rules directly into the machine learning model 105.

In various embodiments, the business rules may identify a task. In the context of the airport apron, example tasks include cleaning the cabin, vacuuming waste from the storage tanks, loading/unloading baggage, de-icing, stocking food and beverage, and mechanical inspection. In other contexts, example tasks include picking a row of produce, inventorying an aisle, or making up hotel rooms along a corridor. The one dimensional RTLS program 101 may thus track the task's progress and, based on the mapped data and/or the machine-learned, estimate a completion time for the task. In the airport context, the one dimensional RTLS program 101 may answer a query as to when a particular aircraft parked at a particular gate is likely to be cleared for takeoff. In response, the one dimensional RTLS program 101 may analyze all of the tasks that need to be accomplished for that plane to take off: cleaning, inspection, loading, boarding, etc., and compare where the required tagged assets to accomplish those tasks are located: in progress on the aircraft, finished, or not yet started, or if, in progress, how long to completion?

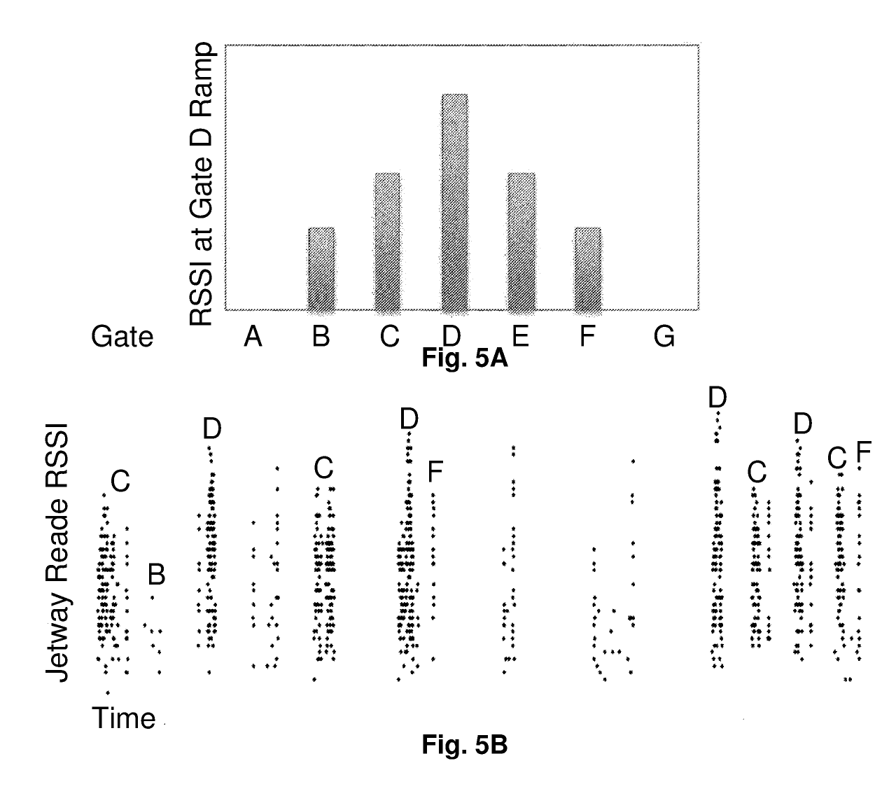

Illustratively of a tag's progress being tracked through an airport, FIG. 5A provides a model of RSSI measured at an active RFID reader at exemplary airport gate D where the tag is in the general area of various nearby gates lettered A-G, with the signal decreasing as the tag is present at the farther gates. FIG. 5B presents a plot of mapped RSSI data with respect to time for a single tag and a single reader, as the tag moves from gate to gate. As shown, intense periods of movement in the projected dimension are identified with activity at not only the gate where the reader is installed: Gate D, but also the surrounding gates. Thus, the one dimensional RTLS program 101, by applying machine learning to larger patterns encompassing movement through multiple separate interactively linear spaces may distinguish among different spaces and apply the business rules to track an asset's progress not only through one task, but between tasks.

More generally, the region, such as the interactively linear region three dimensional region 120, includes a three dimensional space wherein one dimension of the three dimensional space includes a metric dimension for the task (e.g., for cleaning the cabin, the dimension of the length of the aircraft). For purposes of the one dimensional RTLS program 101, the one dimensional representation 103 represents the metric dimension, and the completion time is based, at least in part, on a measurement of progress of the tag along the metric dimension.

FIG. 6 is a block diagram depicting components of a computer 600 suitable for executing the one dimensional RTLS program 101. FIG. 6 displays the computer 600, the one or more processor(s) 604 (including one or more computer processors), the communications fabric 602, the memory 606, the RAM, the cache 616, the persistent storage 608, the communications unit 610, the I/O interfaces 612, the display 620, and the external devices 618. It should be appreciated that FIG. 6 provides only an illustration of one embodiment and does not imply any limitations with regard to the environments in which different embodiments may be implemented. Many modifications to the depicted environment may be made.

As depicted, the computer 600 operates over a communications fabric 602, which provides communications between the cache 616, the computer processor(s) 604, the memory 606, the persistent storage 608, the communications unit 610, and the input/output (I/O) interface(s) 612. The communications fabric 602 may be implemented with any architecture suitable for passing data and/or control information between the processors 604 (e.g., microprocessors, communications processors, and network processors, etc.), the memory 606, the external devices 618, and any other hardware components within a system. For example, the communications fabric 602 may be implemented with one or more buses or a crossbar switch.

The memory 606 and persistent storage 608 are computer readable storage media. In the depicted embodiment, the memory 606 includes a random access memory (RAM). In general, the memory 606 may include any suitable volatile or non-volatile implementations of one or more computer readable storage media. The cache 616 is a fast memory that enhances the performance of computer processor(s) 604 by holding recently accessed data, and data near accessed data, from memory 606.

Program instructions for the one dimensional RTLS program 101 may be stored in the persistent storage 608 or in memory 606, or more generally, any computer readable storage media, for execution by one or more of the respective computer processors 604 via the cache 616. The persistent storage 608 may include a magnetic hard disk drive. Alternatively, or in addition to a magnetic hard disk drive, the persistent storage 608 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of the persistent storage 608.

The communications unit 610, in these examples, provides for communications with other data processing systems or devices. In these examples, the communications unit 610 may include one or more network interface cards. The communications unit 610 may provide communications through the use of either or both physical and wireless communications links. The one dimensional RTLS program 101 may be downloaded to the persistent storage 608 through the communications unit 610. In the context of some embodiments of the present invention, the source of the various input data may be physically remote to the computer 600 such that the input data may be received and the output similarly transmitted via the communications unit 610.

The I/O interface(s) 612 allows for input and output of data with other devices that may operate in conjunction with the computer 600. For example, the I/O interface 612 may provide a connection to the external devices 618, which may include a keyboard, keypad, a touch screen, and/or some other suitable input devices. External devices 618 may also include portable computer readable storage media, for example, thumb drives, portable optical or magnetic disks, and memory cards. Software and data used to practice embodiments of the present invention may be stored on such portable computer readable storage media and may be loaded onto the persistent storage 608 via the I/O interface(s) 612. The I/O interface(s) 612 may similarly connect to a display 620. The display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying one or more tag readers, said one or more of tag readers being positioned peripherally to a region;
receiving a signal, by at least one of said one or more tag readers, from a tag;
determining a received signal strength indication for at least one of said one or more tag readers;
mapping at least one said received signal strength indication onto at a one dimensional representation of said region to yield a mapped data;
performing pattern recognition on said mapped data to yield a pattern data; and
applying machine learning to said pattern data to locate said tag within said region.

2. The computer-implemented method of claim 1, wherein:
said received signal strength indication comprises a time series; and
said mapped data comprises a plot of said received signal strength indication against said time series.

3. The computer-implemented method of claim 1, further comprising:
determining an identifier for said tag, based on said signal; and
determining, based on said identifier, one or more business rules relating to said tag.

4. The computer-implemented method of claim 3 wherein applying machine learning to said pattern data to locate said tag within said region is based on said one or more business rules.

5. The computer-implemented method of claim 3, further comprising:
identifying a task, said task being associated with said tag, based on said one or more business rules; and
estimating a completion time for said task, based on said mapped data.

6. The computer-implemented method of claim 5, wherein:
said region comprises a three dimensional space;
one dimension of said three dimensional space comprises a metric dimension for said task;
said one dimensional representation represents said metric dimension; and
estimating said completion time for said task is based, at least in part, on a measurement of progress of said tag along said metric dimension.

7. The computer-implemented method of claim 1, wherein said region comprises at least one space associated with an aircraft selected from the group consisting of:
(a) a cabin of said aircraft;
(b) a tarmac area beneath said aircraft;
(d) a jet bridge associated with said aircraft;
(e) a cargo hold of said aircraft;
(f) a first airport gate area associated with said aircraft; and
(g) a second airport gate area proximate to said first airport gate area.

8. The computer-implemented method of claim 1, wherein said region is subject to one or more equipment restrictions.

9. A system comprising:
one or more tag readers;
said one or more tag readers being positioned peripherally to a region;
a tag;
one or more processors;
one or more computer readable storage media;
computer program instructions;
said computer program instructions being stored on said one or more computer readable storage media;
said computer program instructions comprising instructions to:
receive a signal, by at least one of said one or more tag readers, from a tag;
determine a received signal strength indication for at least one of said one or more tag readers;
map at least one said received signal strength indication onto at a one dimensional representation of said region to yield a mapped data;
perform pattern recognition on said mapped data to yield a pattern data; and
apply machine learning to said pattern data to locate said tag within said region.

10. The system of claim 9, wherein:
said received signal strength indication comprises a time series; and
said mapped data comprises a plot of said received signal strength indication against said time series.

11. The system of claim 9, wherein said computer program instructions further comprise instructions to:
determine an identifier for said tag, based on said signal; and
determine, based on said identifier, one or more business rules relating to said tag.

12. The system of claim 11 wherein said instructions to apply machine learning to said pattern data to locate said tag within said region is are performed based on said one or more business rules.

13. The system of claim 11, wherein said computer program instructions further comprise instructions to:
identify a task, said task being associated with said tag, based on said one or more business rules; and
estimate a completion time for said task, based on said mapped data.

14. The system of claim 13, wherein:
said region comprises a three dimensional space;
one dimension of said three dimensional space comprises a metric dimension for said task;
said one dimensional representation represents said metric dimension; and
estimating said completion time for said task is based, at least in part, on a measurement of progress of said tag along said metric dimension.

15. The system of claim 13, wherein said region is subject to one or more equipment restrictions.

16. A computer program product comprising one or more computer readable storage media and program instructions stored on said one or more computer readable storage media, said program instructions comprising instructions to:
identify one or more tag readers, said one or more of tag readers being positioned peripherally to a region;
receive a signal, by at least one of said one or more tag readers, from a tag;
determine a received signal strength indication for at least one of said one or more tag readers;
map at least one said received signal strength indication onto at a one dimensional representation of said region to yield a mapped data;
perform pattern recognition on said mapped data to yield a pattern data; and
apply machine learning to said pattern data to locate said tag within said region.

17. The computer program product of claim 16, wherein:
said received signal strength indication comprises a time series; and
said mapped data comprises a plot of said received signal strength indication against said time series.

18. The computer program product of claim 16, wherein said program instructions further comprise instructions to:
determining an identifier for said tag, based on said signal; and
determining, based on said identifier, one or more business rules relating to said tag.

19. The computer program product of claim 18 wherein said instructions to apply machine learning to said pattern data to locate said tag within said region are performed based on said one or more business rules.

20. The computer program product of claim 18, wherein said program instructions further comprise instructions to:
identify a task, said task being associated with said tag, based on said one or more business rules; and
estimate a completion time for said task, based on said mapped data.
